(19) United States
(12) Patent Application Publication
(10) Pub. No.: US 2017/0180957 A1
(43) Pub. Date: Jun. 22, 2017

(54) CALLER-SPECIFIED MEDIA IN COMPUTER TELECOMMUNICATIONS SYSTEMS

(71) Applicant: NAJI LAKKIS, Bucharest (RO)

(72) Inventor: NAJI LAKKIS, Bucharest (RO)

(21) Appl. No.: 14/973,516

(22) Filed: Dec. 17, 2015

(51) Int. Cl. H04W 4/16; H04M 1/725; H04M 3/42

(52) U.S. Cl. CPC H04W 4/16; H04M 3/42059; H04M 1/72555; H04M 1/72552; H04M 1/72547; H04M 3/42076

(57) ABSTRACT

In an embodiment, a data processing method providing an improvement in calls via mobile wireless telecommunications comprises receiving at a server computer, from a calling device comprising a first mobile computing device, mobile call data comprising a media file and an identifier associated with a called device comprising a second mobile computing device; storing the media file at the server computer; transmitting the media file from the server computer to the second mobile computing device using the identifier; using the identifier, initiating a mobile wireless call between the first mobile computing device and the second mobile computing device; and causing displaying the media file on the second mobile computing device in conjunction with indicia indicating that the mobile wireless call is incoming.

### FIELD OF THE DISCLOSURE

The present disclosure generally relates to improving calls in mobile wireless telephone communications. The disclosure relates more specifically to computer-implemented methods, using networked mobile computing devices and server computers, that facilitate sending and receiving images, videos, text and other media at the sane time that calls are placed or received in a mobile network, and in which callers specify the media.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Mobile devices may call one another through mobile wireless calls or VoIP calls. When a user receives a call, the mobile device may display an indication of an incoming voice call. The mobile device may also display caller information such as the caller's name, the phone number of the incoming voice call, or an image that the callee previously has associated with the caller.

However, when a user receiving a call (a “callee”) views the indication of the incoming call, the callee typically does not know what the subject of the call may be about. If callee does not know the phone number or identity of the caller, the callee may not be inclined to answer the call. A caller may send a text message to the callee before the call, indicating that the caller wishes to call and the subject of the call. But it is not guaranteed the callee will view the message prior to receiving the call. Further, in conventional mobile devices, the text message typically is sent using an application or mechanism that is different than the phone application or calling application that is used to place or receive the call.

### SUMMARY

The appended claims may serve as a summary of the invention.

### BRIEF DESCRIPTION OF THE DRAWINGS

In the drawings:

FIG. 1 illustrates a networked computer system arrangement that may be used to implement an embodiment.

FIG. 2 illustrates a computer-implemented process for conducting a mobile wireless call, in an embodiment.

FIG. 3 illustrates a media file selection screen, in an embodiment.

FIG. 4 illustrates a media file upload screen, in an embodiment.

FIG. 5 illustrates a media file upload complete screen, in an embodiment.

FIG. 6A illustrates an incoming call with a digital image file, in an embodiment.

FIG. 6B illustrates an incoming call with a video file, in an embodiment.

FIG. 6C illustrates an incoming call with an audio file, in an embodiment.

FIG. 6D illustrates an incoming call with a text file, in an embodiment.

FIG. 6E illustrates an incoming call with a location file, in an embodiment.

FIG. 6F illustrates an incoming call with a business card file, in an embodiment.

FIG. 7A illustrates a save file prompt with a video file, in an embodiment.

FIG. 7B illustrates a save file prompt with an audio file, in an embodiment.

FIG. 7C illustrates a save file prompt with a location file, in an embodiment.

FIG. 7B illustrates a save file prompt with a digital image file, in an embodiment.

FIG. 7E illustrates a save file prompt with a text file, in an embodiment.

FIG. 7F illustrates a save file prompt with a business card, in an embodiment.

FIG. 8 illustrates a computer system that may be used to implement aspects of an embodiment.

### DETAILED DESCRIPTION

In the following description, for the purposes of explanation, numerous specific details are set forth in order to provide a thorough understanding of the present invention. It will be apparent, however, that the present invention may be practiced without these specific details, in other instances, well-known structures and devices are shown in block diagram form in order to avoid unnecessarily obscuring the present invention.

1.0 General Overview

In an embodiment, a data processing method providing an improvement in calls via mobile wireless telecommunications comprises receiving at a server computer, from a calling device comprising a first mobile computing device, mobile call data comprising a media file and an identifier associated with a called device comprising a second mobile computing device; storing the media file at the server computer; transmitting the media file from the server computer to the second mobile computing device using the identifier; using the identifier, initiating a mobile wireless call between the first mobile computing device and the second mobile computing device; and causing displaying the media file on the second mobile computing device in conjunction with indicia indicating that the mobile wireless call is incoming.

In an embodiment, the data processing method further comprises storing the media file at the second mobile computing device.

In an embodiment, the data processing method further comprises receiving at a server computer, from a first copy of a calling application program executed at the first mobile computing device, the mobile call data comprising the media file and the identifier associated with the second mobile computing device; storing the media file at the server computer; transmitting the media file from the server computer to a second copy of the calling application program that is executed at the second mobile computing device; using the first copy of the calling application program, initiating a mobile wireless call between the first mobile computing device and the second mobile computing device; using the second copy of the calling application program, causing displaying the media file on the second mobile computing device in conjunction with indicia indicating that the mobile wireless call is incoming.

In another aspect, a data processing method comprises sending to a server computer, from a calling device comprising a first mobile computing device that is executing a first instance of a calling application, mobile call data comprising (a) an identifier associated with a called device comprising a second mobile computing device and (b) a selected media item to be shown at the second mobile computing device at a time of initiating a call to the second mobile computing device; by the first instance of the calling application, requesting the server computer to initiate a mobile wireless call between the first mobile computing device and the second mobile computing device based on the identifier, and to cause the second mobile computing device to show the media item via a display screen of the second mobile computing device in conjunction with indicia indicating that the mobile wireless call is incoming, by a single second instance of the calling application that is executed at the second mobile computing device; wherein the media item is any of a text file, an audio file, a video file, a universal resource locator (URI) or network location identifier.

In yet another instance, a data processing method comprises with a first instance of a calling application executing at a first mobile computing device, selecting, from among a plurality of available media items, a media item to be sent to a second mobile computing device, and also selecting a called party identifier for use in placing a mobile phone call to the second mobile computing device; with the first instance of the calling application, sending a request to a server computer to place a mobile phone call to the second computing device and to provide the media item in association with the mobile phone call, wherein the request comprises a called device identifier that is based on the called party identifier, and comprises the media item; with the first instance of the calling application, processing voice data associated with the mobile phone call between the first mobile computing device and the second mobile computing device after the server computer has placed the call and provided the media item to the second computing device.

2.0 System Overview

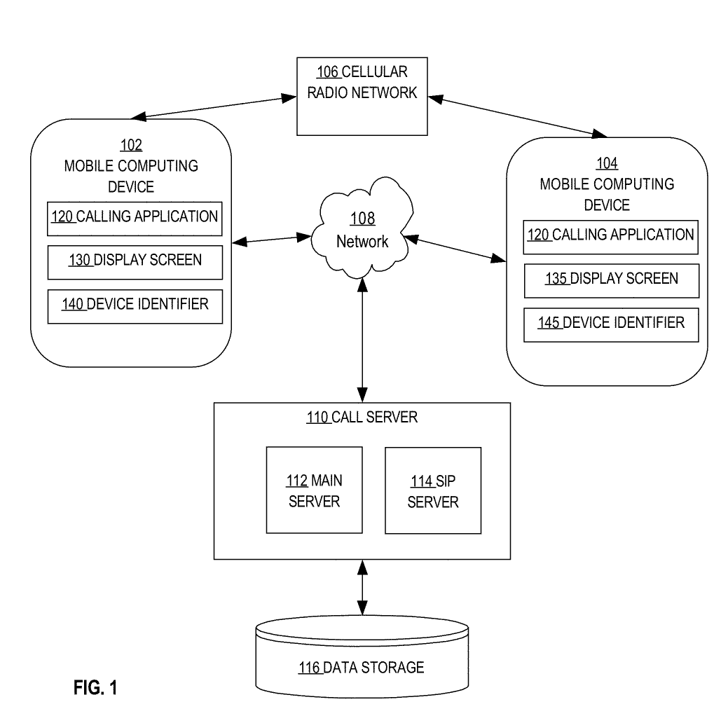

FIG. 1 illustrates a networked computer system arrangement that may be used to implement an embodiment.

In one embodiment, the computer system comprises one or more mobile computing devices 102, 104, a cellular radio network 106, a data communications network 108, and at least one call server 110 coupled to one or more units of data storage 116.

In various embodiments, each of the mobile computing devices 102, 104 comprises a smartphone, tablet computer, netbook computer, laptop computer, or other moveable computer. Examples include Apple iPhone and iPad devices, Android devices, etc. Typically, wireless links couple the mobile computing devices 102, 104 to network 108, which broadly represents one or more local area networks, wide area networks, internetworks, global interconnected internetworks such as the public Internet, or a combination thereof. The wireless links may use networking protocols such as Wi-Fi.

Additionally or alternatively, each of the mobile computing devices 102, 104 may comprise a cellular radio transceiver and may be connected by a wireless cellular radio network 106, which supports receiving cellular phone calls, routing the calls from caller to callee, and maintaining a wireless, radiofrequency call connection during a cell phone call between the devices.

For purposes of illustrating a clear example, FIG. 1 shows two mobile computing devices 102, 104, one cellular radio network 106, and network 108; however, practical implementations may use thousands or millions of mobile devices and any number of interconnected networks.

In an embodiment, mobile computing device 102 further comprises a display screen 130 and a device identifier 140. Mobile computing device 104 also comprises a display screen 135 and device identifier 145. Each device identifier 140, 145 may be a unique identifier that is associated with the mobile computing device. In an embodiment, the device identifier 140, 145 is associated with or comprises a mobile phone number. In other embodiments, the device identifier 140, 145 may comprise a universal identifier (UUID), advertising identifier, or other identifier that is unique to the associated device 102, 104.

In an embodiment, each of the mobile computing devices 102, 104 hosts, executes, or otherwise comprises an instance of a calling application 120. As described further herein, the calling application 120 is configured or programmed both to initiate voice or video calls between mobile computing devices, and to facilitate selection by a caller, communication to a callee, and presentation to the callee of one or more media items that the caller selects at the time of a call. The media items may include text data, sound files, video files, image files, and other media. In one embodiment, each instance of the calling application 120 is configured or programmed as a mobile device application computer program, or mobile app. In another embodiment, the functions described herein for the calling application 120 are integrated into a voice call application or phone app of a mobile device operating system for the mobile computing device 102, 104, such as IOS, ANDROID, WINDOWS MOBILE, etc.

The call server 110 may comprise a computer that is associated with a developer, author or publisher of a mobile app, with a call service provider such as a VoIP or Wi-Fi service provider, or with a cellular network provider. In various embodiments, call server 110 may be implemented as a standalone computer, a server farm, a datacenter or one or more instances of servers or applications in a shared computing facility such as a cloud computing center, with or without virtualization of instances.

The call server 110 may be configured to send and receive mobile call data from the mobile computing devices 102, 104. The mobile call data may comprise media files and a device identifier for a mobile computing device receiving the call. In an embodiment, the call server 110 processes and stores the received media files. Additionally or alternatively, call server 110 may initialize and facilitate calls between mobile computing devices. Call server 110 may be coupled to data storage 116, which may be programmed or configured to store data that is obtained or received from the mobile computing devices 102.

In an embodiment, for example, to improve network speeds and server performance, call server 110 may comprise one or more servers that share or divide responsibility for functions handled by call server 110. In one embodiment, main server 112 sends and receives mobile call data to and from mobile computing devices 102, and stores received data to data storage 116, and a SIP server 114 initiates and facilitates calls between mobile computing devices 102. Main server 112 and SIP server 114 may be one or more software or hardware based servers, in various embodiments.

The call server 110 and the calling application 120 may be programmed or configured in a compatible manner to facilitate communication between the two of them according to a request-response protocol. For example, call server 110 may define an application programming interface (API) consisting of a set of object, method or function identifiers, and the calling application 120 may be programmed or configured to form and transmit invocations of the objects, methods or functions using the API names or call names. The invocations may be packaged, for example, in payloads of HTTP or HTTPS GET or POST requests that are transmitted via TCP/IP from a calling mobile computing device 102, 104 to an HTTP server at the call server 110, which unpacks the invocations from the HTTP payloads, determines a name of an object, method or function that was called, as well as one or more values of parameters or attributes that are in the invocation or call, and then programmatically invokes the called object, method or function and provides the values of the parameters or attributes. Any such invocation may cause forming one or more result data values that are transiently stored at the call server 110 and then packaged in an HTTP POST response that is transmitted back to the calling device 102 via TCP/IP and HTTP or HTTPS. The mobile computing devices 102, 104 may use such invocations to request initiating a call, sending a media file, accepting a call, terminating or rejecting a call, and performing other functions as further described herein.

2.1 Device Identifier

The device identifier is an identifier associated with the mobile computing device 102, 104. When a call server 110 receives mobile call data, it uses the device identifier to determine which mobile computing device 102, 104 the call is directed to. The call server 110 may use the device identifier to connect a mobile wireless can to the associated mobile computing device 102, 104. In an embodiment, the device identifier is associated with the phone number for the device 102, 104.

In one embodiment, each mobile computing device 102, 104 stores a contact file comprising a list of contacts and corresponding phone numbers. An instance of the calling application 120 accesses the contact file to determine a list of contacts available for a mobile wireless call. A user of the mobile computing device 102, 104 may select a contact from the list of contacts. Based on the phone number of the selected contact, the calling application determines a device identifier for the mobile wireless call and sends a request to initiate a call to the call server 110, which request includes the device identifier.

In an embodiment, the device identifier comprises the phone number of a mobile computing device 102, 104 and an indication of the country of origin for the mobile computing device. For example, a mobile computing device 102, 104 in the United States with phone number “(555)123-4567” may have a device identifier of “+15551234567,” where “+1” is the “country code” for the United States. A “country code” indicates the country of origin for a phone number. Country codes may include a “+” symbol or start with “00.”

However, phone numbers stored in the contact file may not include a country code. In an embodiment, the calling application l 20 automatically determines the device identifier by checking the phone number for a country code. If the phone number does not include a country code, then the calling application 120 may determine and use a country code and may optionally update the contact file to include the country code that was determined In an embodiment, the calling application uses the country code in which the mobile computing device is then currently located, as indicated by GPS data or other location information managed by an operating system or location service of the mobile computing device 102, 104. Additionally or alternatively, the calling application determines a country code based on a country name, abbreviation or other value in an address stored in the contact file.

2.2 Media Selection

Other sections below describe functions and operations of the calling application 120 that may be used to place calls, send media, and display media in connection with a received call. For the purpose of providing initial context and orientation to the disclosure, selected functions are described now in general, followed by further detail in other sections.

In an embodiment, a caller may use the calling application 120 to select a particular media file to send to the callee in association with a mobile wireless call at the time that the call is initiated. The particular media file may be selected from among a plurality of stored media files that may include, for example, video files, audio files, digital image files, text files, and location files.

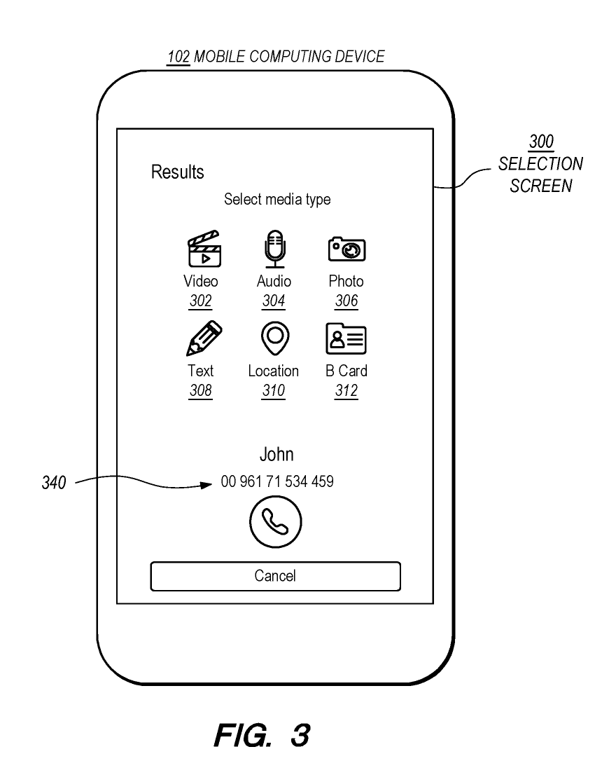

FIG. 3 illustrates an example media selection screen, in an embodiment. Mobile computing device 102 displays selection screen 300 under program control of the calling application 120 and all functions of the screen that are described herein may comprise programmed operations of the calling application. Selection screen 300 allows the caller to select a category of media file to add to a mobile wireless call. Selection screen 300 comprises six selections, in the embodiment of FIG. 3: Video 302, Audio 304, Photo 306, Text 308, Location 310, and B Card 312 (business card). Selection screen 300 also displays device identifier 340, which indicates a target mobile computing device 104 for receiving the call. After the caller selects a type of media file, the caller may select the file from storage accessible to the mobile computing device 102, or create the media file.

In an embodiment, a graphical selection denoted Video 302 is programmed or configured for use to select a video file. The calling application 120 may be programmed to receive a selection of an existing video file, or record a video using a camera on the mobile computing device.

In an embodiment, a graphical selection denoted Audio 304 is programmed or configured for use to select an audio tile. The calling application 120 may be programmed receive a selection of an existing audio file, or record an audio clip using a microphone on the mobile computing device. The audio file may include, for example, recordings, music, ringtones, audio clips, or other types of audio files on the mobile computing device.

In an embodiment, a graphical selection denoted Photo 306 is programmed or configured for use to select a digital image file. Digital images may comprise, for example, photos, images, screenshots, logos, or other types of digital image files. The calling application 120 may be programmed to receive a selection of an existing image, or to take a photo using a camera on the mobile computing device.

In an embodiment, a graphical selection denoted Text 308 is programmed or configured for use to select a text file. Text files may comprise one or more lines of user-inputted words and emoticons. The calling application 120 may be programmed to receive input for the one or more lines of text. In an embodiment, calling application 120 may he programmed to receive a selection of a font, font size, font color, and/or animation effects for the one or more lines of text.

In an embodiment, a graphical selection denoted Location 310 is programmed or configured for use to select a location. The location may include the global positioning system (GPS) coordinates of the mobile computing device or a location selected by the caller. The calling application 120 may be programmed to receive input for a particular location using a map application, or use the current location of the mobile computing device. The calling application 120 may retrieve the current location of the mobile computing device from a map application, or using a global positioning system on the mobile computing device, the location of a cellular radio network tower connected to the mobile computing device, or other methods of geolocation.

In an embodiment, calling application 120 may be programmed to receive a selection of more than one type of media file. For example, calling application 120 may be programmed to receive a selection of a video file and input one or more lines of text to be displayed with the video file.

In an embodiment, calling application 120 may be programmed to receive a selection of B Card 312 to select a business card that comprises text and images. The calling application 120 may be programmed to receive input to select or create a business card. The business card comprises one or more lines of text and images. The calling application 120 may be programmed to receive a selection of an image and one or more lines of text for the image. The text may include the caller's name, email address, phone number, or other types of contact information.

In an embodiment, the caller selects Text 308, but may select a sticker instead of inputting one or more lines of text. A “sticker” comprises an image, such as an illustration or an animation, with text as part of the image. The calling application 120 may include one or more pre-defined stickers for the caller to select.

In an embodiment, calling application 120 may be programmed to send the mobile call data to the call server 110 once the caller has selected a media file and a device identifier, in an embodiment, the call application 120 sends the selected media file and the device identifier to the main server 112 of call server 110. As a result, call server 110 acquires a request to place a call; a device identifier indicating the called device or callee; and a media file to send in association with the call.

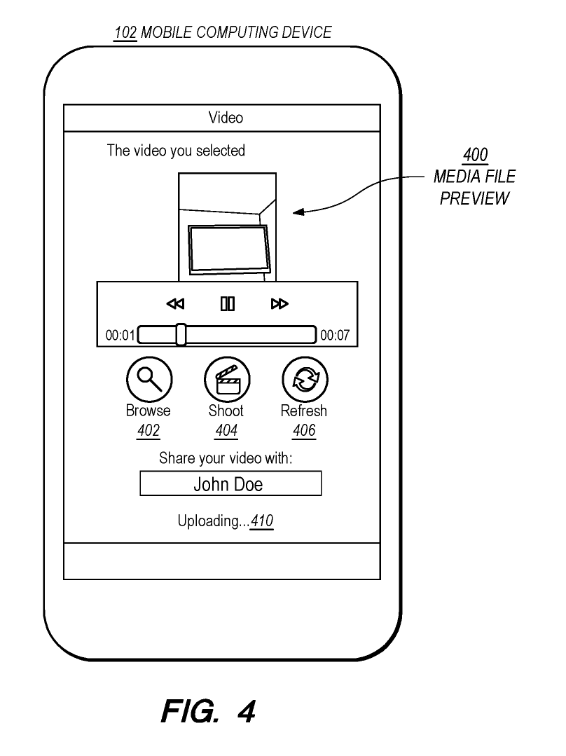

FIG. 4 illustrates an example media upload screen for a video file, in an embodiment. In the following description of FIG. 4, each function or operation that is described comprises a function or operation that is configured or programmed as part of the call application 120.

Upload screen 400 comprises media file preview 402, browse button 404, capture button 406, refresh button 408, and upload indicator 410. Media file preview 402 is configured or programmed to cause displaying the selected media file. Browse button 404 is configured or programmed to receive input to select an existing media file from digital storage accessible to the mobile computing device 102. Capture button 406 is configured or programmed to receive input to create a media file. Refresh button 408 is configured or programmed to re-load the media file displayed in media file preview 402.

Upload indicator 410 is configured or programmed to cause displaying the status of the media upload. In the present example, upload indicator 410 displays text indicating the media file is uploading. In an embodiment, the upload indicator 410 may include information indicating the progress of the media file upload. For example, upload indicator 410 may include a percentage of file uploaded, a progress bar, or other indicators.

After the selected media file is uploaded to the call server 110, the caller may use functions of call application 120 to initiate or connect a call with which the media file will be delivered.

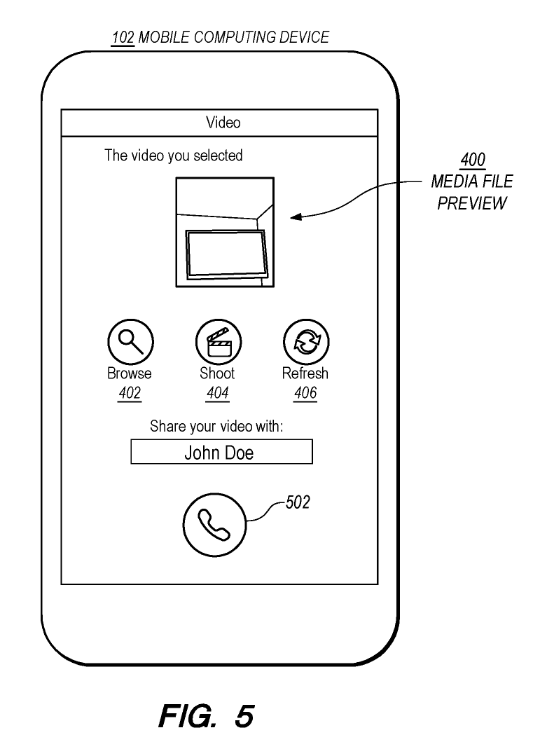

FIG. 5 illustrates an example upload complete screen, in an embodiment.

Upload complete screen 500 comprises media file preview 402, browse button 404, capture button 406, and refresh button 408. However, instead of the upload indicator 410, upload complete screen 500 comprises call button 502. The user may select the call button 502 to indicate to a call server that the call should be connected.

3.0 Process Overview

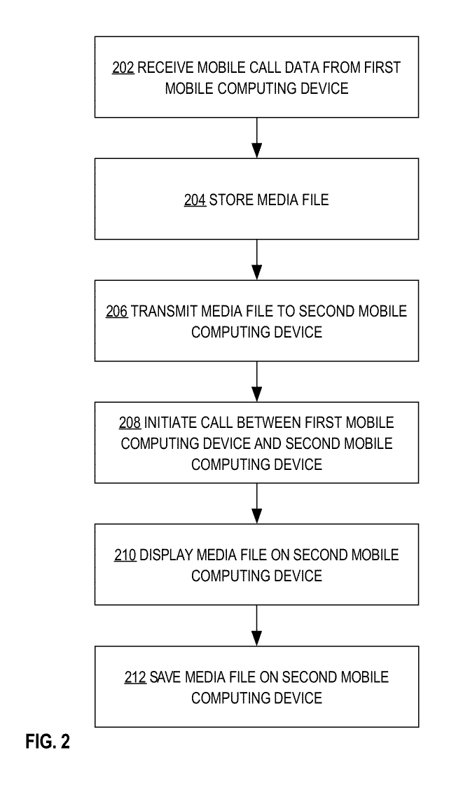

FIG. 2 illustrates an embodiment of a computer-implemented process that may be used to implement an embodiment. For purposes of illustrating a clear example, the process of FIG. 2 is described herein with reference to FIG. 1, but other embodiments may be used in connection with different computer arrangements that yield equivalent or similar functional results. In an embodiment, calling application 120 may be programmed or configured to execute the process of FIG. 2 using program code prepared using JAVA, C++, OBJECTIVE-C, C, or any other suitable source language and then compiled, linked or otherwise transformed into executables that may execute at mobile computing devices 102, 104 and call server 110.

3.1 Receiving Mobile Call Data

At block 202, a server computer receives mobile call data from a first mobile computing device. For example, call server 110 receives mobile call data from mobile computing device 102 (FIG. 1). The mobile call data may comprise a user-specified media file and a device identifier. The media file may comprise one or more of a digital image, a video file, an audio file, a text tile, or location information. In one embodiment, the main server 112 of call server 110 receives the mobile call data from a first mobile computing device 102.

3.2 Storing Media Files

At block 204, the server computer stores the media file. In the present example, the main server 112 stores the media file in data storage 116.

In an embodiment, if the media file is a digital image file, main server 112 creates a reduced size thumbnail based on the received digital image file. Main server 112 stores the full size, original digital image file in data storage 116. The reduced size thumbnail may be stored in data storage 116, or may be cached in local memory of main server 112.

In an embodiment, if the media file is an audio file, main server 112 digitally compresses the audio file to create a compressed audio file. Main server 112 may store the original, uncompressed audio file or the compressed audio file in data storage 116. The compressed audio file may also be cached in local memory of main server 112.

In an embodiment, if the media file is a video file, main server 112 digitally compresses the video file to create a compressed video file. Main server 112 may store the original, uncompressed video file or the compressed video file in data storage 116. The compressed video file may also be cached in local memory of main server 112.

After the file is uploaded to the server computer and stored, the server computer may proceed with the mobile wireless call by transferring the media file to a destination mobile computing device and connecting the call. In an embodiment, the call is not initialized until the media file is transferred to the second mobile computing device.

Referring again to FIG. 5, upload complete screen 500 shows the uploaded file, with the option to select or record a new file, or place the call. The user of the first mobile computing device may choose whether to connect the call or cancel the call. If the user chooses to cancel the call, any files cached in local memory of main server 112 may be discarded, but media files saved in data storage 116 may remain.

3.3 Transferring Media Files

At block 206, the server computer transmits the media file to a second mobile computing device. In the present example, main server 112 transmits the media file to mobile computing device 104, which is the called device, and the media file is received by the instance of calling application 120 that is executing at the called device.

In an embodiment, the media file is a digital image file and main server 112 creates a reduced size thumbnail based on the received digital image file. Main server 112 may transmit the thumbnail to the second mobile computing device 104 instead of transmitting the full size image.

In an embodiment, the media file is an audio file and main server 112 digitally compresses the audio file to create a compressed audio file. Main server 112 may stream the compressed audio file to the second mobile computing device 104.

In an embodiment, the media file is a video file and main server 112 digitally compresses the video file to create a compressed video file. Main server 112 may stream the compressed video file to the second mobile computing device 104.

3.4 Initiating Mobile Wireless Call

At block 208, the server computer initiates a mobile wireless call between the first mobile computing device and the second mobile computing device. In an embodiment, the first mobile computing device 102 and the second mobile computing device 104 are connected by a cellular radio network 106, and the mobile wireless call may be a cellular radio call using the cellular radio network. Or, the call between devices 102, 104 may be a voice over IP call that is carried using packet data over networks TCP/IP as part of network 108.

3.5 Displaying Media Files

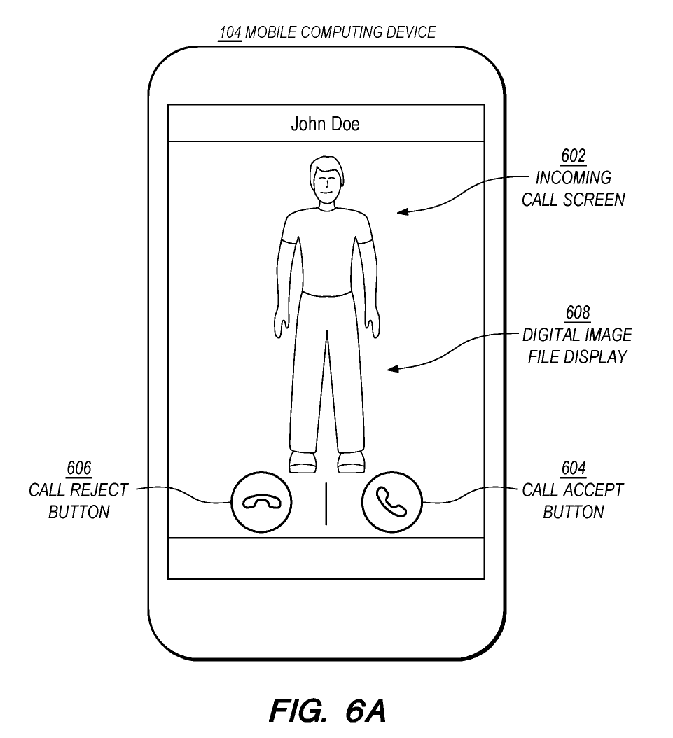

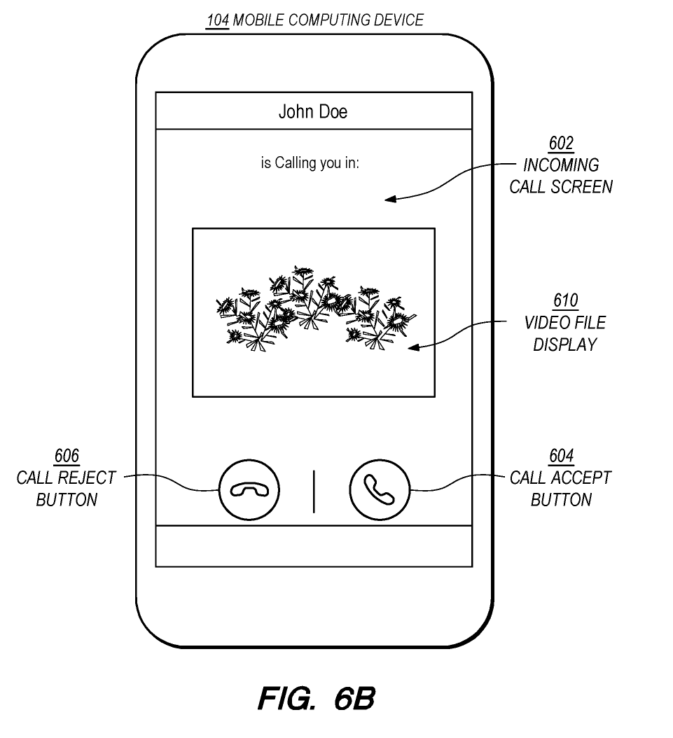

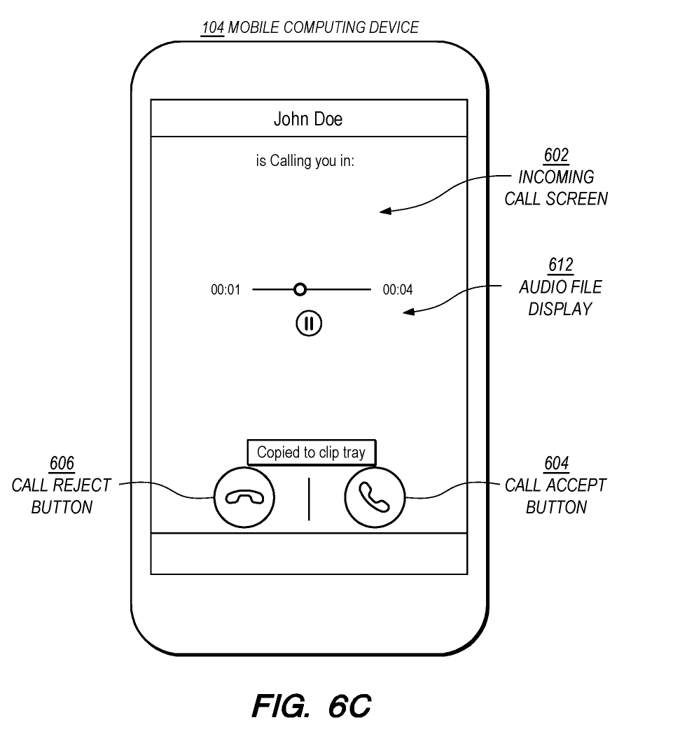

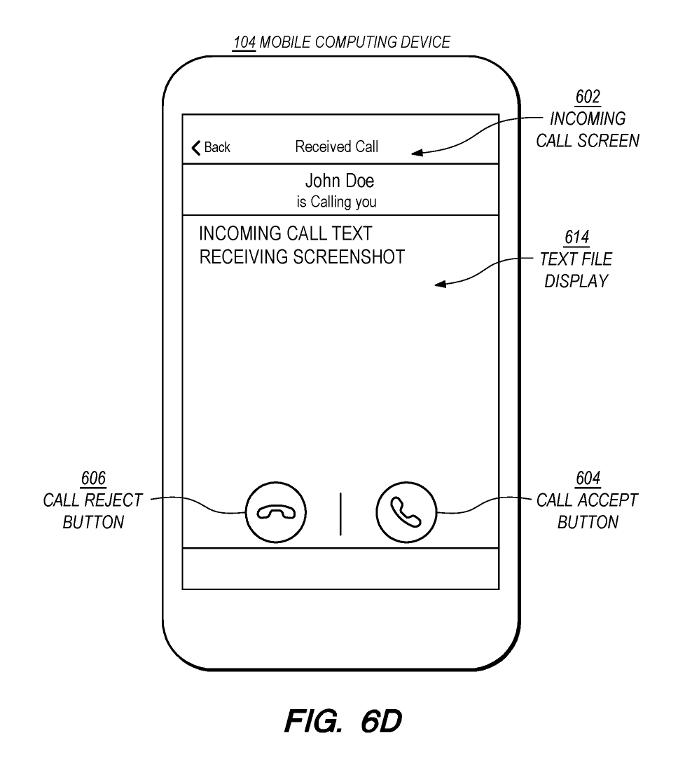

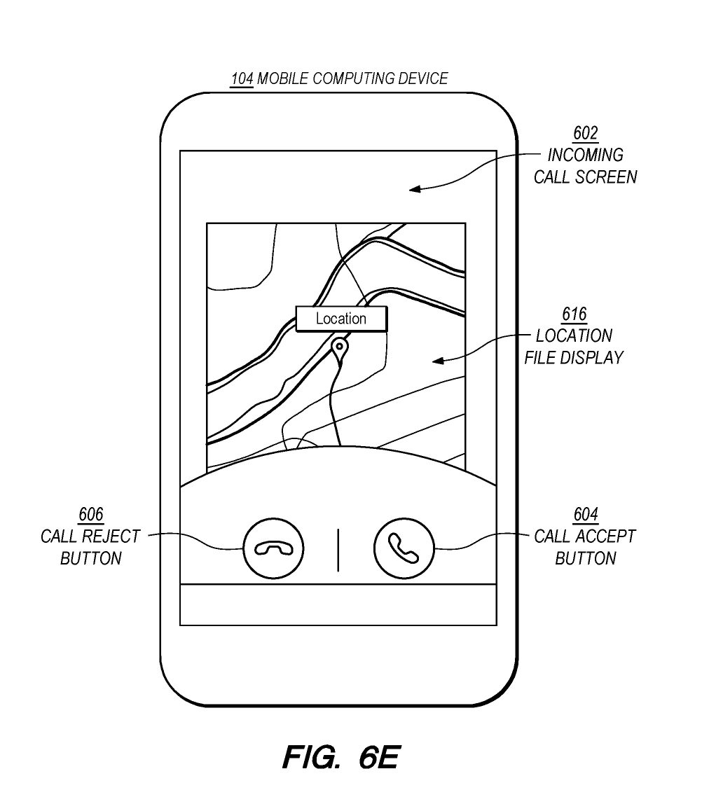

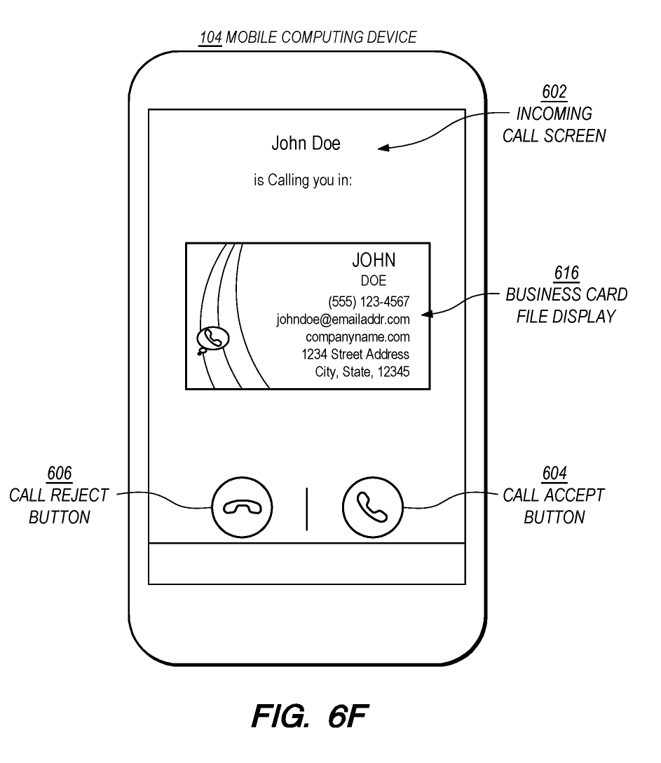

At block 210, the media file is displayed on the second mobile computing device. In an embodiment, the media-file is displayed on the second mobile computing device 104 in conjunction with displaying an indication of an incoming call. In the present example, mobile device 104 displays the media file using display screen 135. FIG. 6A, FIG. 6B, FIG. 6C, FIG. 6D, FIG. 6E, FIG. 6F illustrate an incoming call with media file display, in an embodiment, at different stages of the progression of a call.

Referring first to FIG. 6A, in one example embodiment, the called mobile computing device 104 displays an incoming call screen 602, which comprises a call reject button 606 and call accept button 604. The calling application 120 may be programmed or configured to receive input from a user receiving the call to reject the call using call reject button 606 or accept the call using call accept button 604,

FIG. 6A illustrates a screen display for an incoming call with a digital image file, in an embodiment. Incoming call screen 602 further comprises digital image file display 608. Digital image file display 608 shows a copy of the digital image file that has been received from main server 112 as part of initiating a call. In an embodiment, main server 112 sends a reduced size thumbnail image. Digital image file display 608 shows the reduced size thumbnail image.

FIG. 6B illustrates an incoming call with a video file, in an embodiment. In this example, the incoming call screen 602 comprises video file display 610. The calling application 120 may be programmed or configured to display a video player window in the form of video file display 610, which then shows a video file that was received from main server 112 as part of initiating an incoming call. In an embodiment, main server 112 streams a compressed video file to mobile computing device 104 using a streaming video protocol over the network 108. Video file display 610 displays the streaming compressed video file as it is received, at the time that the call is placed to the device. In another embodiment, video file display 610 comprises graphical interface tools that allow the user to control the video playback. For example, video file display 610 may comprise trick play buttons for pausing or rewinding the video.

FIG. 6C illustrates an incoming call with an audio file, in an embodiment. In the example of FIG. 6C, the calling application 120 may be programmed or configured to cause the incoming call screen 602 to provide an audio file display 612. Audio file display 612 shows a progress bar for playing an audio file that was received at the device 104 from the main server 112, as part of initiating an incoming call, while the audio file plays through speakers connected to mobile computing device 104. In an embodiment, main server 112 streams a compressed audio file to mobile computing device 104. Mobile device 104 plays the streaming compressed audio file as it is received. In another embodiment, audio file display 612 comprises graphical interface tools that allow the user to control the audio playback. For example, audio file display 612 may comprise buttons for pausing or rewinding the audio.

In other examples relating to FIGS. 6B, 6C, in various embodiments, the calling application 120 may be programmed or configured to deliver continuous streams of video data or audio data from a content delivery network rather than a particular file that was selected by the caller and specified to the main server 112. For example, in one alternative, the media file selection process that has been previously described may be programmed or configured to receive input from the caller specifying a URL, other internet location, channel, service and channel, or other data specifying a video stream, audio stream, channel or service from which video or audio may be obtained. Examples include specifications of internet streaming radio stations, streaming music services such as APPLE RADIO or PANDORA, locations of videos or music in content delivery networks such as YOUTUBE or NETFLIX, etc. In response, the instance of the calling application 120 at the called device 104 may be programmed or configured to initiate a streaming playback request via network 108 to the specified location or service, and to deliver the resulting streaming media continuously to the incoming call screen 602. The continuous streaming could be paused or terminated in response to input from a called party, such as selection of a pause button, an end button, or selection of the call accept button 604.

FIG. 6D illustrates an incoming call with a text file, in an embodiment. Incoming call screen 602 comprises text file display 614. Text file display 614 displays one or more lines of text received from main server 112. In an embodiment, the caller may select a font, font size, font color, and/or animation effects for the one or more lines of text. Text file display 614 displays the one or more lines of text including the selected font, font size, font color, and/or animation effects.

FIG. 6E illustrates an incoming call with a location file, in an embodiment. Incoming call display screen 602 comprises location file display 616. Location file display 616 may display a map indicating a location that was received from main server 112. In some embodiments, the main server 112 communicates a URL of an internet map, or geo-location coordinates such as a lat-long pair, or other location data and, in response, the calling application 120 may be programmed or configured to invoke a map application on the called device 104 and to find and display the specified location using the map application.

FIG. 6F illustrates an incoming call with a business card file, in an embodiment. Incoming call display screen 602 comprises business card file display 618. Business card file display 618 displays the image and one or more lines of text, including contact information, sent by main server 112.

3.6 Saving Media Files

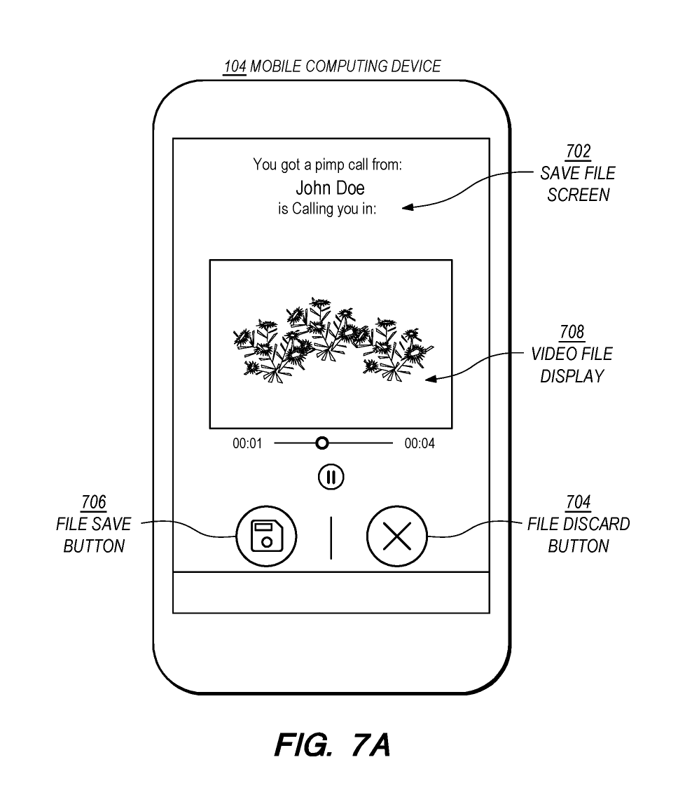

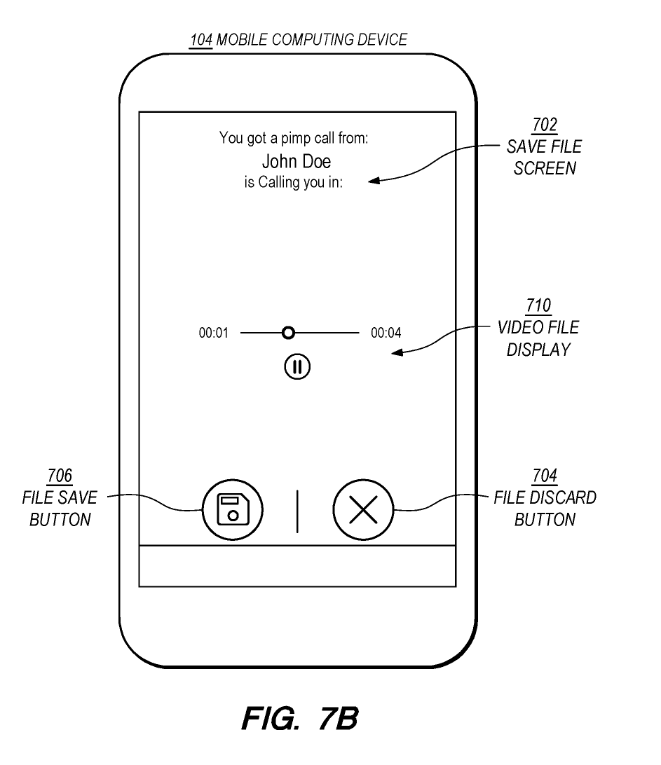

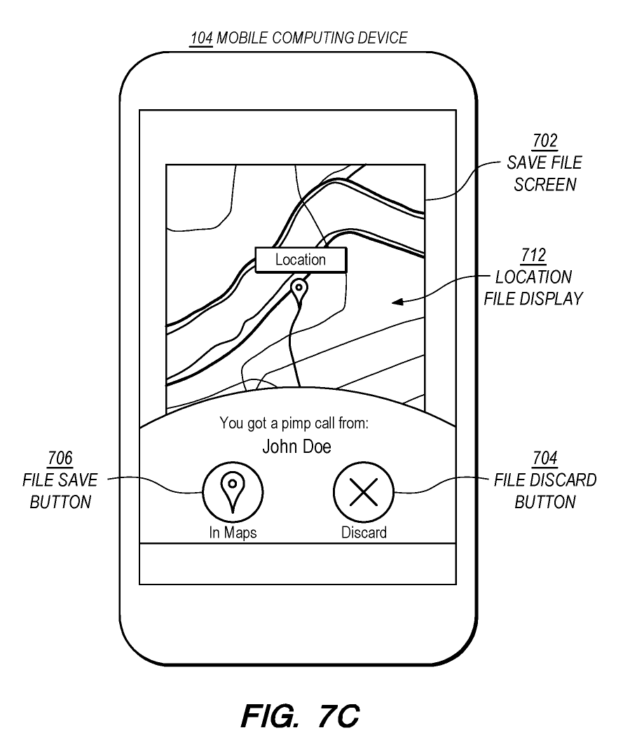

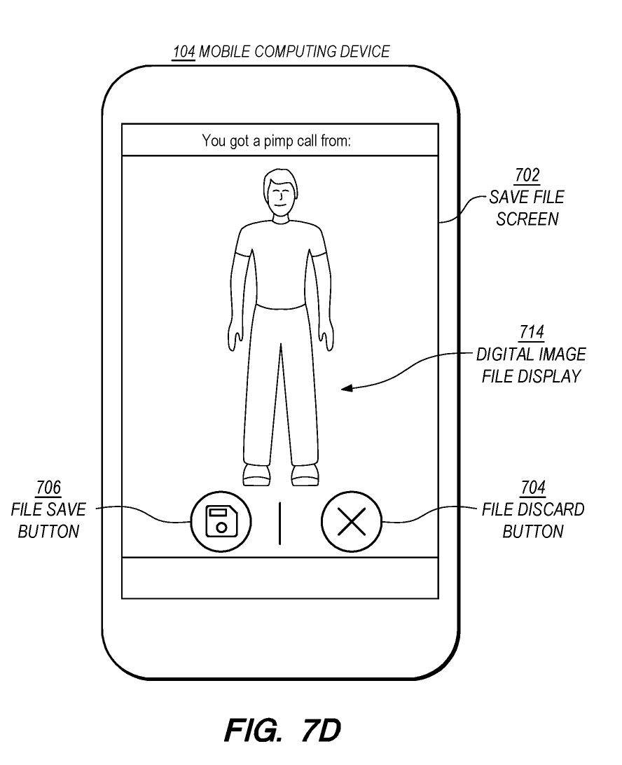

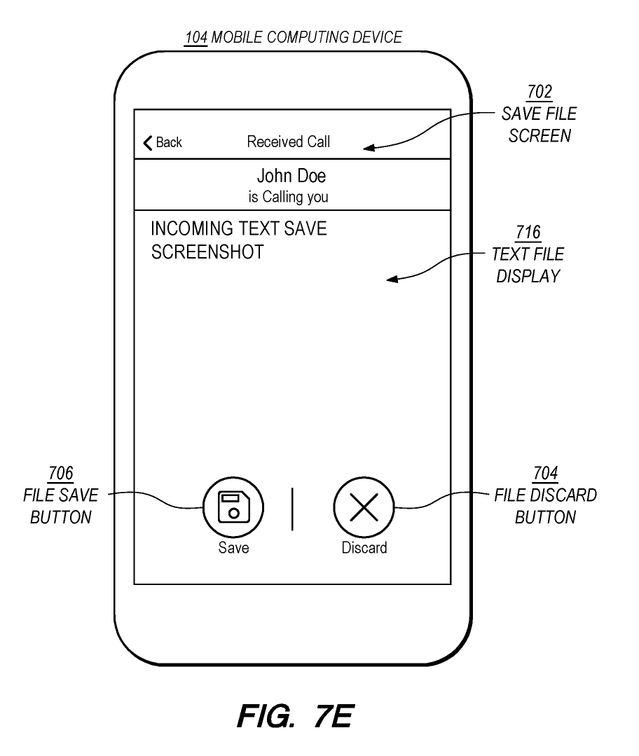

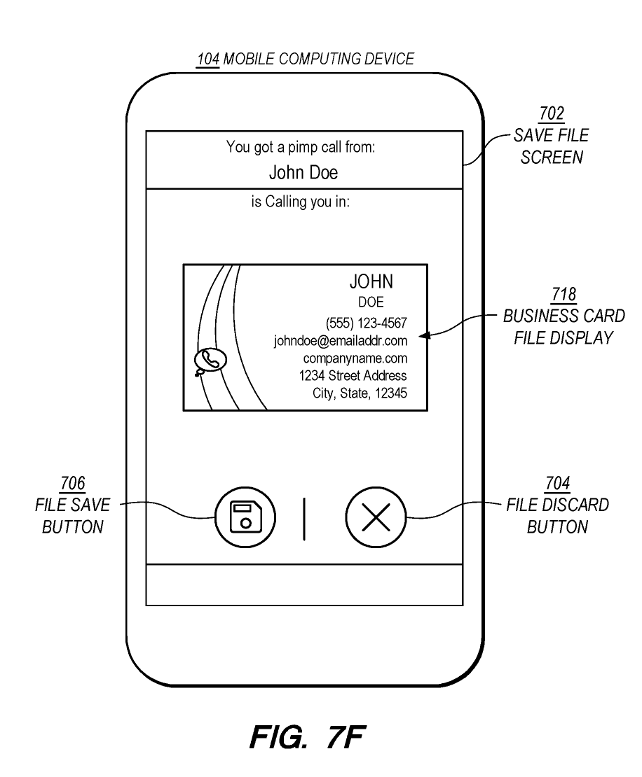

In an embodiment, when the call is complete, a media file that was received at the second mobile computing device may be saved at the second mobile computing device. The media file may be stored in digital storage that is locally accessible to the second mobile computing device, or using network storage. The media file may be opened in another mobile app that can open the particular type of media file. FIG. 7A, FIG. 7B, FIG. 7C, FIG. 7D, FIG. 73, FIG. 7F illustrate a save media file screen, in an embodiment.

Referring first to FIG. 7A, a save file screen 702 comprises file save button 706 and file discard button 704. A user that received a call may select the file save button 706 to save the file or open in another mobile app. The callee may select the file discard button 704 to exit the save file screen without saving. FIG. 7A illustrates a save file prompt with a video file, in an embodiment. Save file screen 702 further comprises video file display 610. In an embodiment, video file display 610 shows a still image from the video file. If the callee selects the file save button 706, then the calling application 120 may store the video file to mobile computing device 104. In an embodiment, mobile computing device 104 received a streaming compressed video file from main server 112. Calling application 120 may request the original, uncompressed video file from main server 112 to save to mobile computing device 104.

FIG. 7B illustrates a save file prompt with an audio file, in an embodiment. Save file screen 702 further comprises audio file display 612. If the callee selects the file save button 706, then the calling application 120 may store the audio file to mobile computing device 104. In an embodiment, mobile computing device 104 received a streaming compressed audio file from main server 112. Calling application 120 may request the original, uncompressed audio file from main server 112 to save to mobile computing device 104.

FIG. 7C illustrates a save file prompt with a location file, in an embodiment. Save file screen 702 further comprises location file display 616. If the callee selects the file save button 706, then the calling application 120 may open a map application to view the location. In an embodiment, the calling application 120 may store the image displayed by location file display 616 as a digital image file.

FIG. 7D illustrates a save file prompt with a digital image file, in an embodiment. Save file screen 702 further comprises digital image file display 608. If the callee selects the file save button 706, then the calling application 120 may store the digital image file to mobile computing device 104. In an embodiment, mobile computing device 104 received a reduced size thumbnail image from main server 112. Calling application 120 may request the original, full size digital image file from main server 112 to save to mobile computing device 104.

FIG. 7E illustrates a save file prompt with a text file, in an embodiment. Save file screen 702 further comprises text file display 614, if the callee selects the file save button, then the calling application 120 may store a digital image file comprising the displayed text.

FIG. 7F illustrates a save file prompt with a business card, in an embodiment. Save file screen 702 further comprises business card file display 618. In an embodiment, if the callee selects the file save button 706, the callee may save the business card file as a digital image file, or be may save the contact information contained in the business card file to the contact file stored on the mobile computing device.

4.0 Benefits of Certain Embodiments

Study of the present disclosure will show that the techniques described herein offer numerous distinct benefits over prior approaches. For example, the efficiency of device-to-device communication is increased because a single calling application 120 may process both voice calls and the delivery of rich media files selected from among text, video, audio and graphics. Further, the use of a mobile phone or other computing device with voice call capability becomes more efficient because the callee can more rapidly identify the caller, or the subject of an incoming call. In yet another aspect, telecommunications is made more efficient because a caller device can transmit, close to the time of an upcoming call, data including text, video or graphics that is directly relevant to, or a foundation of, the content that the caller device is configured or planning to communicate during the call.

In some embodiments, both a selected media file and voice call packet data may be communicated using the same calling application 120, relatively concurrently, over the same network 106, 108 or virtual network channel in one of those networks. That is, in some embodiments, a first TCP/IP connection between a calling mobile computing device 102 and call server 110 can be used to send a media file that is directed to the called mobile computing device 104, followed close in time by audio call packet data over a second TCP/IP connection that uses the same network 106 or network 108. Only a single network (either network 106 or network 108), and a single calling application 120, is needed to handle both media types in relation to a particular call. Similarly, on the delivery side, the call server 110 can use a single network and two closely successive TCP/IP connections to deliver the media file to the called mobile computing device 104 and to deliver audio packet data relating to a voice call from the caller to the callee. Consequently, some embodiments also are directed to solving interact-centric problems such as how to communicate both a media file and a related packet audio call over the same network at close periods in time to a single device using a single mobile application.

Embodiments also provide the unusual and unconventional approach of enabling a calling device, such as mobile computing device 102, to specify and force presentation of a media file at the called device, such as mobile computing device 104, at the same time as an incoming call to the called device. That is, in some embodiments, if the user of a called device such as mobile computing device 104 wishes to inspect information about an incoming call in response to a ringtone, vibration or other alert, the called user does not have the option not to see or view the media file that the calling application 120 delivers to the screen of the called device at the time that the incoming call arrives. Instead, to see any detail about an incoming call, the user of the called device necessarily views a set of text, an image, or a video that the caller has selected and specified for delivery as part of the incoming call. The callee can, of course, elect to decline the call, but typically only after viewing the text, image or video that the caller specified, because the calling application 120 implements both mobile phone call processing functions and media file dispatching, receiving, rendering and display functions.

5.0 Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

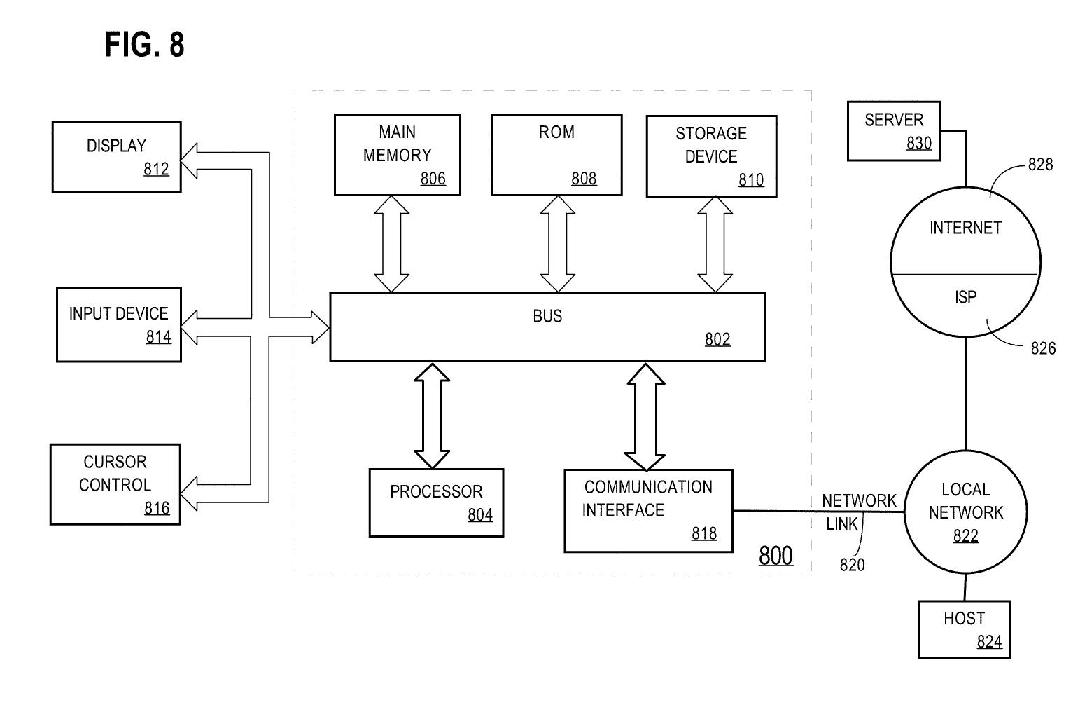

For example, FIG. 8 is a block diagram that illustrates a computer system 800 upon which an embodiment of the invention may be implemented. Computer system 800 includes a bus 802 or other communication mechanism for communicating information, and a hardware processor 804 coupled with bus 802 for processing information. Hardware processor 804 may be, for example, a general purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions,

Computer system 800 further includes a read only memory (ROM) 808 or other static storage device coupled to bus 802 for storing static information and instructions for processor 804. A storage device 810, such as a magnetic disk, optical disk, or solid-state drive is provided and coupled to bus 802 for storing information and instructions.

Computer system 800 may be coupled via bus 602 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may he read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 810. Volatile media includes dynamic memory, such as main memory 806. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions ma initially be carried on a magnetic disk or solid-state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A data processing method providing an improvement in calls via mobile wireless telecommunications, the method comprising:
receiving at a server computer, from a calling device comprising a first mobile computing device, mobile call data for initiating a mobile wireless call, the mobile call data comprising a media file and an identifier associated with a called device comprising a second mobile computing device;
in response to receiving the mobile call data, the server computer:
storing the media file at the server computer;
transmitting the media file from the server computer to the second mobile computing device using the identifier;
using the identifier, initiating the mobile wireless call between the first mobile computing device and the second mobile computing device; and
causing displaying the media file on the second mobile computing device in conjunction with indicia indicating that the mobile wireless call is incoming.

2. The method of claim 1, further comprising storing the media file at the second mobile computing device.

3. The method of claim 1 wherein the media file is a first digital image and transmitting the media file further comprises:
creating a reduced size thumbnail digital image based upon the first digital image; and
transmitting, from the server computer to the second mobile computing device, the thumbnail digital image;
displaying the thumbnail digital image on the second mobile computing device as part of displaying the media file.

4. The method of claim 1, wherein the media file is an audio file, and further comprising transmitting the media file by digitally compressing the audio file to form a compressed audio file, and streaming the compressed audio file from the server computer to the second mobile computing device.

5. The method of claim 4, wherein displaying the media file on the second mobile computing device further comprises playing the streaming audio file on the second mobile computing device.

6. The method of claim 1, wherein the media file is a video file, and transmitting the media file further comprises digitally compressing the video file to create a compressed video file and streaming the compressed video file from the server computer to the second mobile computing device.

7. The method of claim 6, wherein displaying the media file on the second mobile computing device further comprises playing the streaming video file on the second mobile computing device.

8. The method of claim 1, wherein the media file comprises location information specifying a geographic location of the first computing device, and displaying the media file on the second mobile computing device further comprises displaying the location information on the second mobile computing device.

9. The method of claim 1, wherein the media file comprises a text file, and displaying the media file on the second mobile computing device further comprises displaying the text file on a screen of the second mobile computing device.

10. The method of claim 1 further comprising:
receiving at a server computer, from a first copy of a calling application program executed at the first mobile computing device, the mobile call data comprising the media file and the identifier associated with the second mobile computing device;
storing the media file at the server computer;
transmitting the media file from the server computer to a second copy of the same calling application program that is executed at the second mobile computing device;
using the first copy of the calling application program, initiating a mobile wireless call between the first mobile computing device and the second mobile computing device;
using the second copy of the calling application program, causing displaying the media file on the second mobile computing device in conjunction with indicia indicating that the mobile wireless call is incoming.

11. The method of claim 1 wherein the transmitting and the initiating are performed close in time.

12. The method of claim 10 further comprising receiving a mobile phone number of the second mobile computing device based upon the first mobile computing device retrieving the mobile phone number from a contact file at the first mobile computing device based upon the identifier.

13. The method of claim 1 wherein the first mobile computing device and the second mobile computing device each comprises a cellular radio transceiver and wherein the mobile wireless call is a cellular radio call.

14. A non-transitory computer-readable medium storing one or more instructions, which when executed by one or more processors, cause the one or more processors to perform a method providing an improvement in calls via mobile wireless telecommunications and comprising:
receiving at a server computer, from a calling device comprising a first mobile computing device, mobile call data for initiating a mobile wireless call, the mobile call data comprising a media file and an identifier associated with a called device comprising a second mobile computing device;
in response to receiving the mobile call data, the server computer:
storing the media file at the server computer;
transmitting the media file from the server computer to the second mobile computing device using the identifier;
using the identifier, initiating the mobile wireless call between the first mobile computing device and the second mobile computing device; and
causing displaying the media file on the second mobile computing device in conjunction with indicia indicating that the mobile wireless call is incoming.

15. The non-transitory computer-readable medium of claim 14, wherein the one or more instructions further comprise instructions which, when executed by one or more processors, cause the one or more processors to perform storing the media file at the second mobile computing device.

16. The non-transitory computer-readable medium of claim 14, wherein the media file is a first digital image and further comprising sequences of instructions which when executed by the one or more processors cause transmitting the media file by:
creating a reduced size thumbnail digital image based upon the first digital image; and
transmitting, from the server computer to the second mobile computing device, the thumbnail digital image;
displaying the thumbnail digital image on the second mobile computing device as part of displaying the media file.

17. The non-transitory computer-readable medium of claim 16, wherein displaying the media file on the second mobile computing device further comprises displaying the thumbnail of the digital image.

18. The non-transitory computer-readable medium of claim 14, wherein the media file is an audio file, and further comprising sequences of instructions which when executed by the one or more processors cause transmitting the media file by digitally compressing the audio file to form a compressed audio file, and streaming the compressed audio file from the server computer to the second mobile computing device.

19. The non-transitory computer-readable medium of claim 18, further comprising sequences of instructions which when executed by the one or more processors cause displaying the media file on the second mobile computing device by playing the streaming audio file on the second mobile computing device.

20. The non-transitory computer-readable medium of claim 14, wherein the media file is a video file, and further comprising sequences of instructions which when executed by the one or more processors cause transmitting the media file further comprises digitally compressing the video file to create a compressed video file and streaming the compressed video file from the server computer to the second mobile computing device.

21. The non-transitory computer-readable medium of claim 20, and further comprising sequences of instructions which when executed by the one or more processors cause displaying the media file on the second mobile computing device by playing the streaming video file on the second mobile computing device.

22. The non-transitory computer-readable medium of claim 14, wherein the media file comprises location information, and further comprising sequences of instructions which when executed by the one or more processors cause displaying the media file on the second mobile computing device by displaying the location information on the second mobile computing device.

23. The non-transitory computer-readable medium of claim 14, wherein the media file comprises a text file, and further comprising sequences of instructions which when executed by the one or more processors cause displaying the media file on the second mobile computing device by displaying the text on a screen of the second mobile computing device.

24. The non-transitory computer-readable medium of claim 14 further comprising sequences of instructions which when executed by the one or more processors cause:
receiving at a server computer, from a first copy of a calling application program executed at the first mobile computing device, the mobile call data comprising the media file and the identifier associated with the second mobile computing device;
storing the media file at the server computer;
transmitting the media file from the server computer to a second copy of the calling application program that is executed at the second mobile computing device;
using the first copy of the calling application program, initiating a mobile wireless call between the first mobile computing device and the second mobile computing device;
using the second copy of the calling application program, causing displaying the media file on the second mobile computing device in conjunction with indicia indicating that the mobile wireless call is incoming.

25. The non-transitory computer-readable medium of claim 14 wherein the transmitting and the initiating are performed close in time.

26. The non-transitory computer-readable medium of claim 14 further comprising causing displaying the media file on the second mobile computing device at a same time as indicia indicating that the mobile wireless call is incoming

27. The non-transitory computer-readable medium of claim 14 further comprising sequences of instructions which when executed by the one or more processors cause receiving a mobile phone number of the second mobile computing device based upon the first mobile computing device retrieving the mobile phone number from a contact file at the first mobile computing device based upon the identifier.

28. A data processing method providing an improvement in calls via mobile wireless telecommunications, the method comprising:
sending to a server computer, from a calling device comprising a first mobile computing device that is executing a first instance of a calling application, mobile call data comprising (a) an identifier associated with a called device comprising a second mobile computing device and (b) a selected media item to be shown at the second mobile computing device at a time of initiating a call to the second mobile computing device;
by the first instance of the calling application, requesting the server computer to initiate a mobile wireless call between the first mobile computing device and the second mobile computing device based on the identifier, and to cause the second mobile computing device to show the media item via a display screen of the second mobile computing device in conjunction with indicia indicating that the mobile wireless call is incoming, by a single second instance of the calling application that is executed at the second mobile computing device;
wherein the media item is any of a text file, an audio file, a video file, a universal resource locator (URL) or network location identifier.

29. The method of claim 28, further comprising streaming the media item to the second mobile computing device via the second instance of the calling application.

30. The method of claim 29 wherein the media item comprises a universal resource locator (URL) or network location identifier for an online video, internet radio station or internet music service.

31. The method of claim 29 wherein the first mobile computing device and the second mobile computing device each comprises a cellular radio transceiver and wherein the mobile wireless call is a cellular radio call.

32. A data processing method comprising:
with a first instance of a calling application executing at a first mobile computing device, selecting, from among a plurality of available media items, a media item to be sent to a second mobile computing device, and also selecting a called party identifier for use in placing a mobile phone call to the second mobile computing device;
with the first instance of the calling application, sending a request to a server computer to place a mobile phone call to the second computing device and to provide the media item in association with the mobile phone call, wherein the request comprises a called device identifier that is based on the called party identifier, and comprises the media item;
with the first instance of the calling application, processing voice data associated with the mobile phone call between the first mobile computing device and the second mobile computing device after the server computer has placed the call and provided the media item to the second computing device.

33. The method of claim 32, wherein the media item is any of a text file, an audio file, a video file, a universal resource locator (URL) or network location identifier.

34. A data processing method providing an improvement in calls via mobile wireless telecommunications, the method comprising:
receiving at a server computer, from a calling device comprising a first mobile computing device, mobile call data for initiating a mobile wireless call, the mobile call data comprising a media file and an identifier associated with a called device comprising a second mobile computing device;
in response to receiving the mobile call data, the server computer:
storing the media file at the server computer;
generating a reduced-size media file based on the media file;
transmitting the reduced-size media file from the server computer to the second mobile computing device using the identifier;
using the identifier, initiating the mobile wireless call between the first mobile computing device and the second mobile computing device; and
causing displaying the reduced-size media file on the second mobile computing device in conjunction with indicia indicating that the mobile wireless call is incoming.
